(19) United States
(12) Patent Application Publication
(10) Pub. No.: US 2012/0191314 A1
(43) Pub. Date: Jul. 26, 2012

(54) ENGINE BRAKE TORQUE MANAGEMENT

(75) Inventors: Manuel TUGNOLO, Collegno (TO) (IT); Luca SCAVONE, Moncalieri (TO) (IT); Alberto CORSIATTO, Torino (IT); Luca CHIAPUSSO, Torino (IT)

(73) Assignee: GM GLOBAL TECHNOLOGY OPERATIONS LLC, Detroit, MI (US)

(21) Appl. No.: 13/356,960

(22) Filed: Jan. 24, 2012

(30) Foreign Application Priority Data
Jan. 24, 2011 (GB) 1101175.6

(51) Int. Cl. B60W 10/06; B60W 10/18

(52) U.S. Cl. 701/70; 477/203

(57) ABSTRACT

A method is provided for controlling the engine torque delivered during engine operation. The method includes, but is not limited to setting a brake torque request value during the engine operation, deriving a request fuel quantity value on the basis of the brake torque request value. The comparison of the value of the brake torque requested with a measured and/or estimated brake torque value allows calculating a brake torque error value, which directly or indirectly modifies the request fuel quantity injected in the engine.

### CROSS-REFERENCE TO RELATED APPLICATION

This application claims priority to British Patent Application No. 1101175.6,filed Jan. 24, 2011, which is incorporated herein by reference in its entirety.

### TECHNICAL FIELD

The technical field relates in general to a method for controlling internal combustion engines operation and, in particular, to a method for controlling the engine torque delivered during engine operation.

### BACKGROUND

Technologies and systems currently used on vehicles, such as automatic transmission, BAS+, LNT and DPF devices need to maintain the engine in correct operating conditions (i.e., correct operating points), and in particular there is the need of a correct engine torque management, in order to control the engine torque delivered, especially during transient conditions. For these purposes, on internal combustion engines mounted on vehicles calibration activities are carried out wherein a set of nominal operation points are established in order to obtain a correct engine operation, in every functioning conditions, and to maintain some functional parameters such as fuel consumptions, emissions, noise, performances and others, on nominal values. The nominal values are established from the engine or vehicle manufacturer in order to improve the driver feelings and vehicle performances but also in order to comply with national and international regulations relating to emissions, noise, etc.

During every day driving and using conditions, it could happen that deterioration of the engine, or at least of a part or a subsystem of the engine, caused by a plurality of factors such as aging, incorrect use or maintenance conditions, etc., adversely affects the correct engine operation, and in particular determine difficult to reach the nominal value (i.e., nominal operating points) established during the calibration activities. In detail, errors caused by engine aging, injectors drift, engine-to-engine dispersion, adversely affect the correct engine operation, and the nominal values established during the calibration process of the engine are not reached, thus the fuel consumption, emissions, performances and noise values are different from those declared and established during the engine calibration process.

The above-reported problems, caused mainly by the deterioration of the engine, lead to different engine operating conditions during everyday use and, as verified by the applicant by means of experimental tests, these problems determine engine operation in different points with respect to those established during the calibration activities. For these reasons, the engine torque amount delivered is different from the nominal requested values.

In view of the above, there is at least a need to control the engine operating conditions and, in particular, to perform an accurate and efficient management of the torque delivered by the engine in order to eliminate adverse effects caused by deterioration, and in particular by engine aging, injectors drift, engine to engine dispersion, etc. It is at least on object to provide a method for controlling the engine torque delivered in order to reach the correct nominal value established during calibration activities. At least another object is to provide a method for controlling the engine, and in particular the engine torque delivered, independently from the deterioration errors, reported above, for example, engine aging, injectors drift, etc., in order to ensure that fuel consumption, emission and noise are always the nominal declared during calibration activities. In addition, other objects, desirable features and characteristics will become apparent from the subsequent summary and detailed description, and the appended claims, taken in conjunction with the accompanying drawings and this background.

### SUMMARY

A method is provided that comprises setting a brake torque request value during the engine operation, deriving a request fuel quantity value on the basis of said brake torque request value, comparing said value of the brake torque requested with a measured and/or estimated brake torque value for calculating a brake torque error value, and modifying directly or indirectly the request fuel quantity injected in said engine on the basis of the brake torque error value. The control method acts on the “engine brake torque” and it should be noted that this expression is used in the present disclosure to indicate the “input gearbox torque”. In other words, according to an embodiment, the method allows to control the engine brake torque delivered by the engine which represents the “real” torque amount requested by the driver during the use, taking also into account the torque amount requested by accessories and other systems or subsystems, for example the air conditioning compressor.

The method allows to perform a control of the torque delivered by the engine, and in particular of the engine brake torque, in order to operate the engine in the nominal set points established during the calibration activities, independently from engine aging, injection drifts, and other errors caused by deterioration effects or malfunctioning conditions. In greater detail, comparing the value of the brake torque requested with a measured and/or estimated brake torque value allows calculating a brake torque error value that is used for modifying directly or indirectly the request fuel quantity injected in the engine. It has to be noted that the brake torque value is measured by means of suitable sensors, and/or estimated on the basis of models, maps, etc. As will be disclosed in greater detail later, the method on the engine brake torque acts in a closed loop control type.

Advantageously, the control of the fuel quantity injected is performed directly or indirectly: in other words, the method allows controlling the torque delivered by the engine by adjusting directly the fuel quantity injected in the engine, or indirectly, for example, by acting on functional parameters of the injection systems. According to an embodiment, the method acts by adjusting the energizing time of the injectors. As already mentioned above, the modification of the injected fuel quantity, directly or indirectly, determine the correction of the operating points of the engine, in order to maintain not only the delivered torque on the nominal set value, but also fuel consumptions, emissions, performances and noise are maintained in the nominal values declared during calibration activities. Usually, in the method, the request fuel quantity is derived on the basis of the value of the brake torque requested, taking also into account the total friction, in order to calculate a brake torque indicated value, which is then used for deriving the request fuel quantity value taking into account at least the engine speed value.

According to an embodiment, the method comprises the step of deriving a request fuel injection quantity delta value on the basis of the brake torque error value, the request injection quantity delta value is then compared with the request fuel quantity value in order to calculate a request fuel quantity adjusted value. The request fuel quantity adjusted value is the output of the closed loop control based on the measured and/or estimated brake torque, which is used for evaluating the error with respect to the request brake torque value, and allows to perform an accurate control on the “real” engine torque requested, in order to maintain the engine operation points in correspondence of the nominal points established during calibration activities.

According to an embodiment, the request fuel injection quantity delta value and the injection fuel quantity request value relates to main/after injection pulses, and in general to “torque forming” injection pulses. Thus, it is possible to control the torque delivered by the engine and to maintain it in the nominal values. In another possibility, the request fuel injection quantity delta value is compared with the total fuel injection quantity, and/or with at least the fuel quantity requested by the rail system, and the air system, in order to calculate a request fuel quantity adjusted value for at least the rail system, the air system and the injection systems.

According to another embodiment, the method further comprises deriving an injectors energizing time delta value on the basis of the brake torque error value, which is compared with the energizing time request value derived from said request fuel quantity value, in order to calculate a request energizing time-adjusted value for indirectly modifying the fuel quantity injected in the engine. By modifying in closed loop control the fuel injection quantity, on the basis of a brake torque error value derived from the comparison of the requested brake torque and the current measured and/or estimated brake torque value, it can be obtained a more efficient and accurate control of the torque delivered by the engine during its operation. Moreover, maintaining the delivered brake torque amount in the calibrated nominal set points increases the confidence of reaching the nominal values established during calibration activities for fuel consumptions, noise, emissions, performances independently from the negative effects of deteriorations errors, and in particular, of engine aging, injectors drift effects, etc.

Furthermore, the closed loop control of the method allows a reduction in the time required for carrying out calibrations activities, and in particular, last minute calibration or re-calibration activities time is reduced in a sensible manner. In fact, the control on the request fuel quantity allows to reach the nominal operating points also with a less accurate calibration level because of a closed loop control based on, as mentioned above, a brake torque error value derived from a measured and/or estimated brake torque value.

Advantageously, improved vehicle driveability, gear-shifting quality are also obtained by the controlling method. Another embodiment provides a computer program comprising computer executable codes for carrying out the method for controlling engine torque delivered during engine operation, described above. The computer program, stored in a computer readable medium includes: a computer executable code for setting a brake torque request value during the engine operation; a computer executable code for deriving a request fuel quantity value on the basis of the brake torque request value; a computer executable code for comparing the value of the brake torque requested with a measured and/or estimated brake torque value for calculating a brake torque error value; a computer executable code for modifying directly or indirectly the request fuel quantity injected in the engine on the basis of the brake torque error value.

Another embodiment is an apparatus for controlling the engine torque delivered during engine operation, the apparatus comprising means for setting a brake torque request value BT_{REQ} during the engine operation, means for deriving a request fuel quantity value I-REQ on the basis of said brake torque request value, means for comparing said value of the brake torque requested BT_{REQ} with a measured and/or estimated brake torque value (BT_{MEAS}) for calculating a brake torque error value (BT_{ERR}), means for modifying directly or indirectly the request fuel quantity injected I-REQ in said engine on the basis of said brake torque error value BT_{ERR}. The apparatus allows performance of a control of the torque delivered by the engine, and in particular, of the engine brake torque, in order to operate the engine in the nominal set points established during the calibration activities, independently from engine aging, injection drifts, and other errors caused by deterioration effects or malfunctioning conditions.

An embodiment of the apparatus has means for deriving a request fuel quantity value I-REQ configured to derive the request fuel quantity value by comparing (e.g., adding) the value of the brake torque requested BT_{REQ} with total friction value TF for calculating a brake torque indicated value, deriving the request fuel quantity value I-REQ on the basis of the brake torque indicated BT_{IND} value and at least the engine speed value.

Still another embodiment of the apparatus has means for deriving a request fuel quantity value I-REQ which are configured to derive a request fuel injection quantity delta value Δ on the basis of said brake torque error value BTERR, the request fuel injection quantity delta value Δ being compared with the request fuel quantity value I-REQ to calculate a request fuel quantity adjusted value I-ADJ. Yet another embodiment of the apparatus has means for deriving a request fuel quantity value I-REQ that are configured such that the request fuel injection quantity delta value Δ and the injection fuel quantity request value I-REQ are fuel injection quantity of main and/or after injection pulses and in particular torque forming injections.

Yet another embodiment of the apparatus is configured such that the request fuel injection quantity delta value Δ and the injection fuel quantity request value I-REQ are total fuel injection quantity considering all the injection pulses. A further embodiment of the apparatus has means for deriving a request fuel quantity value I-REQ that compare the request fuel injection quantity delta value Δ with the fuel quantity value request I-REQ for at least the rail system I-REQRAIL, the air system I-REQAIR, and for the injectors I-REQTOT, to calculate a request fuel quantity adjusted value for at least the rail system I-ADJRAIL, the air system I-ADJAIR, and the injectors I-ADJTOT.

Another embodiment of the apparatus comprises means for deriving an injectors energizing time delta value ΔET on the basis of the brake torque error value BTERR, the injectors energizing time delta value ΔET being compared with the energizing time request value I-REQET derived from said request fuel quantity value I-REQ, to calculate a request energizing time adjusted value I-ADJET.

### BRIEF DESCRIPTION OF THE DRAWINGS

The present invention will hereinafter be described in conjunction with the following drawing figures, wherein like numerals denote like elements, and:

FIG. 1 is a schematic flow chart of method for controlling the torque delivered during the engine operation based on the closed loop control of the main/after injections fuel quantity (torque forming injection pulses) according to an embodiment;

FIG. 2 is a schematic flow chart of method for controlling the torque delivered during the engine operation based on the closed loop control of the total fuel quantity (all the injection pulses) according to an embodiment;

FIG. 3 a schematic flow chart of method for controlling the torque delivered during the engine operation based on the closed loop control of the fuel quantity request for rail system, air system, and injection systems according to an embodiment; and

FIG. 4 a schematic flow chart of method for controlling the torque delivered during the engine operation based on the closed loop control of the energizing time of the main injections according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The method for controlling the engine torque delivered during engine operation, comprises the steps of setting a brake torque request value BT_{REQ} during the engine operation and deriving a request injection fuel quantity value, generally indicated as I-REQ on the basis of the brake torque request value. Generally, the request fuel quantity value I-REQ is derived by adding to the value of the brake torque requested BT_{REQ} with a total friction value TF, which describes with both measured and/or estimated values the total amount of friction in the engine, subsystems, etc., for calculating a brake torque indicated value BT_{IND}. A request injection fuel quantity value I-REQ is derived on the basis of the brake torque indicated value BT_{IND}, obtained as explained above, and at least the engine speed value ES.

In greater detail, the request fuel quantity value I-REQ, which is the injection fuel quantity necessary for engine operation and for delivering a desired brake torque amount taking into account also friction effects, is measured and/or estimated trough a map function of engine speed ES and the indicated brake torque value BT_{IND}. According to an embodiment of the method, the comparison of the value of the request brake torque BT_{REQ} with a measured and/or estimated brake torque value BT_{MEAS} allows to calculate a brake torque error value BT_{ERR}; which is used for modifying directly or indirectly the request fuel quantity value I-REQ injected in the engine. Advantageously, the method acts as a closed loop control on the request fuel quantity value I-REQ by means of a brake torque error value BT_{ERR} which represents the difference between the desired brake torque request BT_{REQ} value and the measured-and/or estimated brake torque value BT_{MEAS,} i.e., the real input gearbox torque requested by the driver.

It has to be noted that the expression modifying “directly or indirectly” the request fuel quantity I-REQ injected in the engine is used to indicate that the fuel quantity request is modified directly by deriving an injection quantity delta value Δ, which is compared with the request fuel quantity value I-REQ to calculate a request fuel quantity adjusted value I-ADJ, or indirectly by modifying the fuel quantity request value I-REQ acting on other parameters, such as injectors functional parameters.

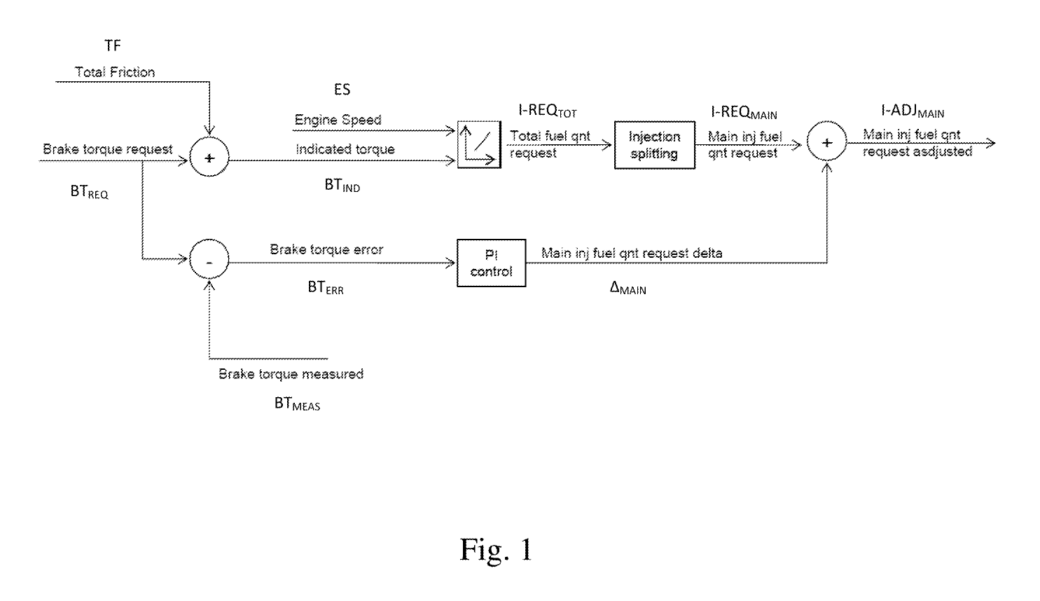

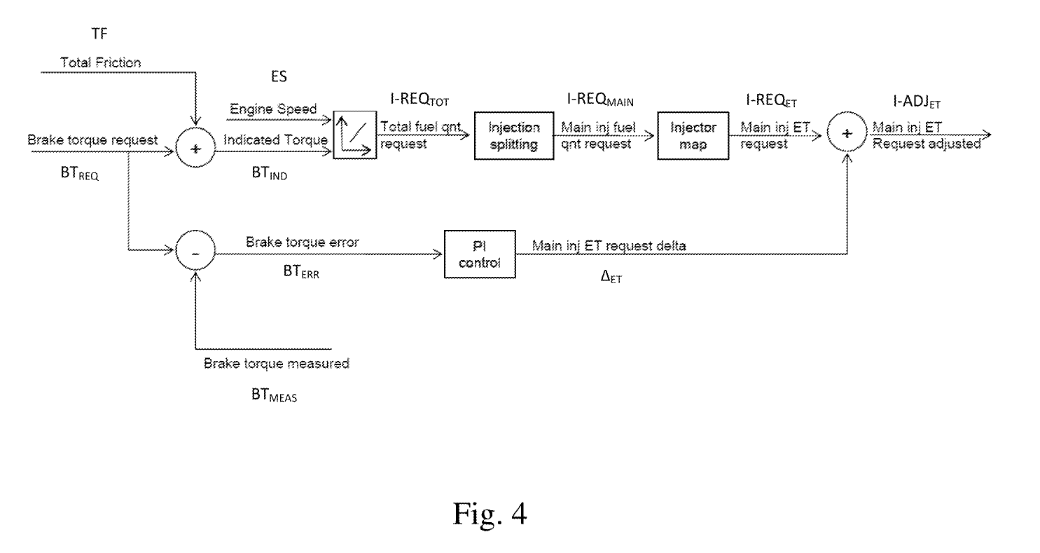

According to an embodiment, the method comprises modifying the request fuel quantity by acting indirectly on the energizing time of the injectors, this embodiment will be disclosed later in connection to FIG. 4. FIG. 1-FIG. 3 show three schematic flow charts of the method for controlling the torque delivered during the engine operation based on the direct modification of the request fuel quantity I-REQ on the basis of the brake torque error BT_{ERR}, value that is traduced in a request fuel injection quantity delta value Δ. The request fuel injection quantity delta value Δ is then compared with the request fuel quantity value I-REQ to calculate a request fuel quantity adjusted value I-ADJ. The modification of the request fuel injection quantity can be carried out on different injection pulses, such as all the total injections pulses, the main and/or after injection pulses, etc.

FIG. 1 shows an embodiment of the method for controlling the torque delivered during the engine operation based on the direct modification of the request fuel quantity of “torque forming” injections, and in particular of main and/or after injection pulses. In other words, as shown in the upper part of the flow chart, for an engine operating point the controlling method sets a brake torque request value BT_{REQ} during the engine operation and derives a request fuel quantity value for the main and/or after injections I-REQ_{MAIN} on the basis of the brake torque request value BT_{REQ}.

Although FIG. 1 shows the control of the main injection pulse, it should be noted the embodiment of the method for controlling the torque delivered during the engine operation is based on the direct modification of the request fuel quantity of “torque forming” injections, i.e., main and/or after injection pulses. Generally, the request fuel quantity value I-REQ is derived by adding to the value of the brake torque requested BT_{REQ} a value relating to the total friction TF, which describes with both measured and/or estimated value the total amount of friction in the engine, subsystems, etc., for calculating a brake torque indicated value BT_{IND}. The brake torque indicated value BT_{IND} is used with the engine speed value for measuring and/or modelling the total fuel quantity request value I-REQ_{TOT} necessary for delivering the brake torque request value, taking into account also the frictional effects (total friction value).

The total fuel injection request value I-REQ_{TOT}, which comprises fuel injection request data for all the injections pulses, is then used for deriving in a known manner, for example by the “injection splitting map” of the engine, the fuel quantity request data for the torque forming injections, and in particular for the main and/or after injections by deriving a main and/or after fuel quantity injection request value I-REQ_{MAIN}. (See the block injection splitting in the upper part of FIG. 1).

As shown in the lower part of the flow chart of FIG. 1, the brake torque error value BT_{ERR} derived from the comparison of the brake torque request value BT_{REQ} and the estimated and or measured brake torque value BT_{MEAS}, is then traduced for example by means of a controller of the proportional-integrative type (PI controller), in a main and/or after injections fuel quantity request delta value Δ_{MAIN}, which represent the correction value for the request fuel quantity value, obtained by taking into account the brake torque error value. The main and/or after injections fuel quantity request delta value Δ_{MAIN} is used in a control of the closed loop type to modify the main and/or after fuel quantity injection request value I-REQ_{MAIN}, by obtaining a main and/or after fuel injection quantity request adjusted value I-ADJ_{MAIN}, which represent the correct amount of fuel necessary for delivering the correct brake torque value required for the engine operation point.

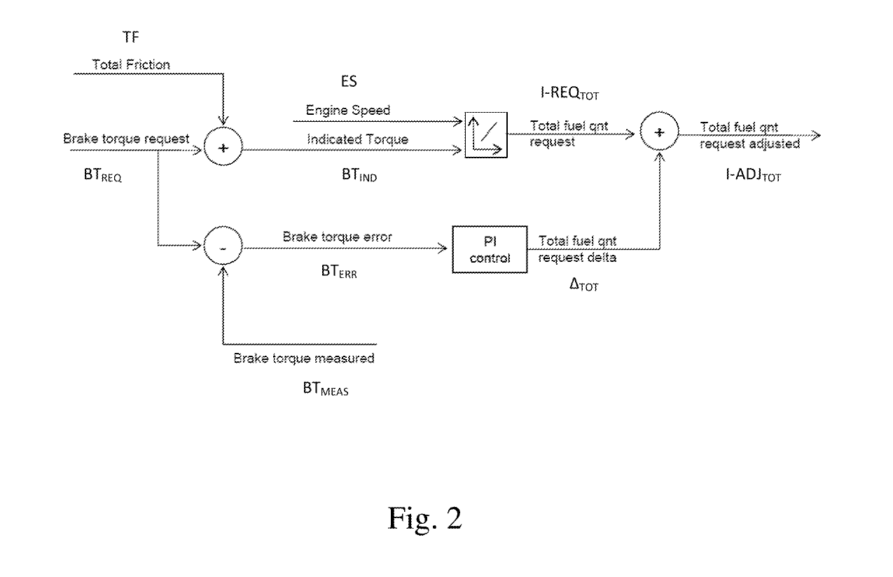

FIG. 2 shows another embodiment of the method for controlling the torque delivered during engine operation based on the direct modification of the request fuel quantity of all the injection pulses I-REQ_{TOT}, i.e., not only torque forming injections, as described above in connection to FIG. 1. As already described above for the embodiment shown in FIG. 1, in the upper part of the flow chart of the method, for an engine operating point the controlling method sets a brake torque request value BT_{REQ} during the engine operation and derives a total request fuel quantity value I-REQ_{TOT} on the basis of the brake torque request value. The total request fuel quantity value I-REQ_{TOT} is derived by adding to the value of the brake torque requested BT_{REQ} a value relating to the total friction TF, which describes with both measured and/or estimated values the total amount of friction in the engine, subsystems, etc., for calculating a brake torque indicated value BT_{IND}. The brake torque indicated value BT_{IND} is used with the engine speed value for measuring and/or modelling, by means of a map, the total fuel quantity request value I-REQ_{TOT} necessary for delivering the brake torque request value BT_{REQ}.

As visible in the lower part of the flow chart of FIG. 2, the brake torque error value BT_{ERR} derived from the comparison of the brake torque request value BT_{REQ} and the estimated and/or measured brake torque value BT_{MEAS}, is then traduced for example by means of a controller of the proportional-integrative type (i.e., PI controller), in a total injectors fuel quantity request delta value Δ_{TOT,} which represent the correction value for the total request fuel quantity value I-REQ_{TOT} based on the brake torque error value BT_{ERR}.

In view of above, the control method schematically represented in FIG. 2 differs from the method shown in FIG. 1 in that the closed loop control for the direct modification of the fuel injection quantity is carried out on the total fuel injection quantity value I-REQ_{TOT}, in fact, the request fuel injection quantity delta value Δ and the injection fuel quantity request value I-REQ relates to total fuel injection quantity. The correct amount of fuel necessary for delivering the correct brake torque value required for the engine operating point is represented by a total fuel injection quantity request adjusted value I-ADJ_{TOT} obtained by the modification of the total injection fuel quantity request value I-REQ_{TOT} by means of the total fuel quantity request delta value Δ_{TOT}.

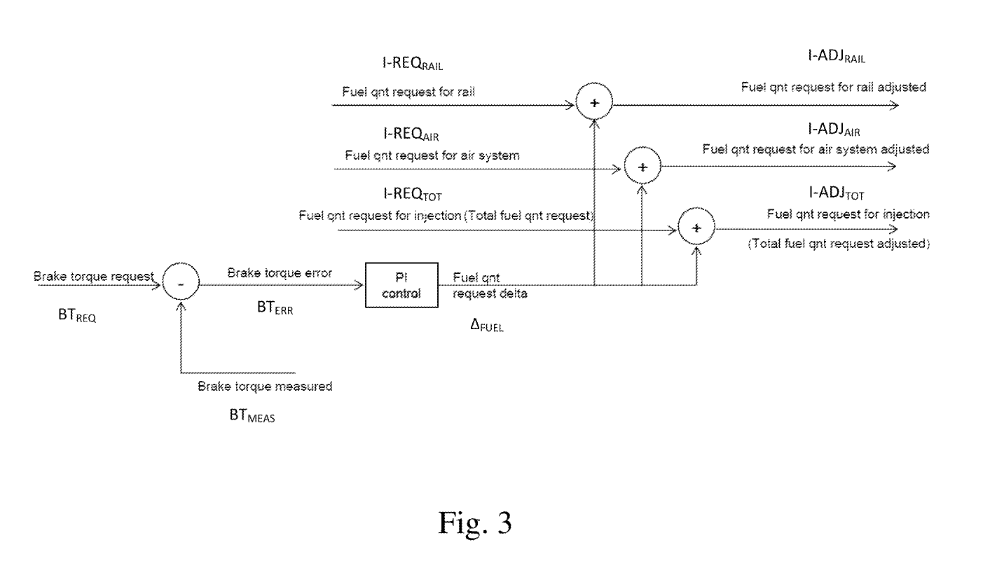

FIG. 3 shows another embodiment of the method for controlling the torque delivered during the engine operation based on the direct modification of the request fuel quantity of all the injection pulses I-REQ_{TOT}, as disclosed above in connection to FIG. 2, and also of the request fuel quantity for the rail system I-REQRAIL and for the air system I-REQ_{AIR}. Even if it is not shown in upper part of the flow chart of FIG. 3, the total fuel quantity request value I-REQ_{TOT} is derived as described above in the embodiment schematically depicted in FIG. 2, i.e., by means of the indicated torque value and the engine speed. In the same manner, also the fuel quantity request for the air system I-REQ_{AIR} and the fuel injection quantity request for the rail system I-REQ_{RAIL} are derived from the indicated torque value and the engine speed by means of a known measuring and/or modelling procedure.

Having regard to the lower part of the flow chart of the method of FIG. 3, the brake torque error value BT_{ERR} derived from the comparison of the brake torque request value BT_{REQ} and the estimated and/or measured brake torque value BT_{MEAS}, is then traduced for example by means of a controller of the proportional-integrative type (i.e., PI controller), in a fuel quantity request delta value Δ_{FUEL,} which represent the correction value for the total request fuel quantity value I-REQ_{TOT}, the fuel injection quantity request value for air system I-REQ_{AIR} and the fuel injection quantity request for the rail system I-REQ_{RAIL}. The output of the system are a set of modified (adjusted) fuel injection quantity request values for the air system I-ADJ_{AIR}, the rail system I-ADJ_{RAIL}, and for all the fuel injection pulses I-ADJ_{TOT}.

FIG. 4 shows a schematic flow chart of the method for controlling the torque delivered during the engine operation based on the indirect modification of the request fuel quantity on the basis of the brake torque error value. As already mentioned above, indirect modification (adjusting) of the request fuel quantity means that the control acts on functional parameters that modify the fuel quantity injected in the engine. According to the embodiment depicted in FIG. 4, the controlling method acts on the energizing time, which is indicated as ET, of the injectors in order to modify the fuel quantity injected in the engine. Preferably, the energizing time of the main injection pulse is controlled.

The upper part of the flow chart of FIG. 4 is similar to the upper part of the flow chart of FIG. 1. The main injection fuel quantity request value I-REQ_{MAIN} is derived starting from the brake torque request value BT_{REQ} that is traduced in the total fuel quantity request value I-REQ_{TOT} and then divided between the fuel injection systems of the engine in order to derive the main injection fuel quantity request value I-REQ_{MAIN}. By means of injector maps, or similar modelling for describing the control of the injectors, the method derives the main injection energizing time request value I-REQ_{ET} necessary for injecting in the engine the main injection fuel quantity.

As shown in lower part of the flow chart of FIG. 4, the method comprises the step of deriving an injectors energizing time delta value Δ_{ET} on the basis of said brake torque error value BT_{ERR}, for example by means of a proportional-integrative controller as described above in connection to FIG. 1-FIG. 3. The injectors energizing time delta value Δ_{ET} is compared with the energizing time request value I-REQ_{ET} derived from the request fuel quantity value I-REQ_{MAIN}, to calculate a request energizing time adjusted value I-ADJ_{ET} necessary to control the delivered torque and to maintain the latter on the requested brake torque value for the engine operating point.

As already disclosed above, all the embodiments described in connections to FIG. 1-FIG. 4 allow obtaining improvements in the control of the torque delivered during engine operation. In particular, the brake torque delivered is maintained on the set nominal points established during the calibration process, thus it is obtained an increased confidence of reaching the nominal values of fuel consumptions, emissions, noise, performances, etc. In fact, the output data of the method, i.e., a modified request injection fuel quantity value I-ADJ on the basis of the brake torque errors value BT_{ERR} allows controlling the torque delivered by the engine in an efficient and accurate manner for allowing the engine operation in the nominal operating points established during the calibration activities. Thus, the torque amount delivered by the engine is always the correct value pre-determined during the calibration process, independently from errors, such as, engine aging, injectors drift, causing engine operation in different points than those established in the calibration activities.

The direct or indirect modification of the request injection fuel quantity I-REQ of the engine by means of a closed loop type control on the basis of the brake torque error value BT_{ERR} allows to improve the engine torque management with the confidence of reaching the nominal values established during the calibration activities of the torque delivered and also of the fuel consumptions, emissions, noise, etc. In other words, by means of the present method the torque delivered value is maintained on the calibrated operating nominal points, and by doing so also fuel consumptions, emission and other engine functional parameters are maintained in correspondence of the nominal points established during the calibration activities.

It is clear that the closed loop control type of the method, based on the “real” brake torque value request by the driver is not negatively affected by aging or deteriorations errors of the engine, or of engine parts, such as injectors drift, etc. Moreover, the controlling method allows improving the vehicle drivability, the gear-shifting quality and the clutch durability. Furthermore, a shorter calibration time is requested, in particular for last minute calibration or re-calibrations activities, thanks to the closed loop control actuated by the claimed controlling method on the request fuel quantity.

Moreover, the preferred implementation embodiment of the controlling method described above in connection to FIG. 1, which perform a modification on the “torque forming” injection pulses, i.e. on the main and/or after injections fuel quantity value, leads to other advantages and improvements. It should be noted that the preferred embodiment of the method based on the control of main and/or after fuel injection quantity (see FIG. 1) is the best in reaching the nominal values of fuel consumptions, noise, performances and emissions and allows a less calibration efforts as well as reduced costs and implementations efforts, with less memory usage and simplified complexity in implementation.

The method for controlling the torque delivered during engine operation described above, may be carried out by means of a computer program comprising program codes (i.e., computer executable codes) for performing the controlling steps already described in connection to FIG. 1-FIG. 4. The computer program comprises computer executable codes that can be stored on a computer readable medium, or a storage unit, such as CD, DVD, flash memory, hard disk, or the like.

The computer program comprises computer executable code for setting a brake torque request value BT_{REQ} during the engine operation; a computer executable code for deriving a request fuel quantity value I-REQ on the basis of the brake torque request value; a computer executable code for comparing the value of the brake torque requested with a measured and/or estimated brake torque value BT_{MEAS} for calculating a brake torque error value BT_{ERR}; a computer executable code for modifying directly or indirectly the request fuel quantity injected I-REQ in the engine on the basis of the brake torque error value.

According to an embodiment, the computer program is stored on storage unit or a computer readable medium that is connected, or integrally produced with an electronic control apparatus for an internal combustion engine. The electronic control apparatus is provided with a microprocessor, or any suitable means known in art, for receiving the computer codes of the computer program and for executing them.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for controlling a torque of an engine delivered during operation of the engine, comprising:
setting a brake torque request value during the operation;
deriving a request fuel quantity value on a basis of said brake torque request value;
comparing said brake torque request value with a brake torque value for calculating a brake torque error value; and
modifying the request fuel quantity value that injected in said engine on a basis of said brake torque error value.

2. The method according to claim 1, wherein the modifying is directly modifying.

3. The method according to claim 1, wherein the modifying is indirectly modifying.

4. The method according to claim 1, wherein deriving the request fuel quantity value comprises:
comparing said brake torque request value with a total friction value for calculating a brake torque indicated value; and
deriving said request fuel quantity value on a basis of said brake torque indicated value and at least an engine speed value.

5. The method according to claim 1, further comprising:
deriving a request fuel injection quantity delta value on a basis of said brake torque error value; and
comparing the request fuel injection quantity delta value with said request fuel quantity value to calculate a request fuel quantity adjusted value.

6. The method according to claim 5, wherein the request fuel injection quantity delta value and the injection fuel quantity request value are fuel injection quantity of main injection pulses.

7. The method according to claim 5, wherein the request fuel injection quantity delta value and the injection fuel quantity request value are fuel injection quantity of after injection pulses.

8. The method according to claim 5, wherein the request fuel injection quantity delta value and the injection fuel quantity request value are total fuel injection quantity that consider at least substantially all injection pulses.

9. The method according to claim 5, further comprising:
comparing the request fuel injection quantity delta value with fuel quantity value request for at least a rail system, an air system, and for injectors; and
calculating the request fuel quantity adjusted value for at least the rail system, the air system, and the injectors.

10. The method according to claim 1, further comprising:
deriving an injectors energizing time delta value on a basis of said brake torque error value,
wherein said injectors energizing time delta value are compared with the injectors energizing time delta value that is derived from said request fuel quantity value to calculate a request energizing time-adjusted value.

11. A computer readable medium embodying a computer program product, said computer program product comprising:
a control program for controlling an torque of an engine delivered during operation of the engine, the control program configured to:
set a brake torque request value during the operation;
derive a request fuel quantity value on a basis of said brake torque request value;
compare said brake torque request value with a brake torque value for calculating a brake torque error value; and
modify the request fuel quantity value that injected in said engine on a basis of said brake torque error value.

12. The computer readable medium embodying the computer program product according to claim 11, wherein the modifying is a directly modify.

13. The computer readable medium embodying the computer program product according to claim 11, wherein the modify is an indirect modify.

14. The computer readable medium embodying the computer program product according to claim 11, wherein the control program is configured to:
compare said brake torque request value with a total friction value for calculating a brake torque indicated value; and
derive said request fuel quantity value on a basis of said brake torque indicated value and at least an engine speed value.

15. The computer readable medium embodying the computer program product according to claim 11, wherein the control program is configured to:
derive a request fuel injection quantity delta value on a basis of said brake torque error value; and
compare the request fuel injection quantity delta value with said request fuel quantity value to calculate a request fuel quantity adjusted value.

16. The computer readable medium embodying the computer program product according to claim 15, wherein the request fuel injection quantity delta value and the injection fuel quantity request value are fuel injection quantity of main injection pulses.

17. The computer readable medium embodying the computer program product according to claim 15, wherein the request fuel injection quantity delta value and the injection fuel quantity request value are fuel injection quantity of after injection pulses.

18. The computer readable medium embodying the computer program product according to claim 15, wherein the request fuel injection quantity delta value and the injection fuel quantity request value are total fuel injection quantity that consider at least substantially all injection pulses.

19. The computer readable medium embodying the computer program product according to claim 15, the control program further configured to:
compare the request fuel injection quantity delta value with fuel quantity value request for at least a rail system, an air system, and for injectors; and
calculate the request fuel quantity adjusted value for at least the rail system, the air system, and the injectors.

20. The computer readable medium embodying the computer program product according to claim 11, the control program further configured to:
derive an injectors energizing time delta value on a basis of said brake torque error value,
wherein said injectors energizing time delta value are compared with the injectors energizing time delta value that is derived from said request fuel quantity value to calculate a request energizing time-adjusted value.
